(19) United States
(12) Patent Application Publication
(10) Pub. No.: US 2009/0078807 A1
(43) Pub. Date: Mar. 26, 2009

(54) Adjustable grinder

(76) Inventor: Yu Wing Tang, Hong Kong (HK)

Correspondence Address: COOPER & DUNHAM, LLP, 30 Rockefeller Plaza, 20th Floor, NEW YORK, NY, 10112, US

(21) Appl. No.: 11/903,308

(22) Filed: Sep. 21, 2007

(51) Int. Cl. A47J 42/08

(52) U.S. Cl. 241/169.1

(57) ABSTRACT

A tapered inner grinding element is spaced apart from an outer grinding element with a space therebetween which defines the size of the ground product. A shaft is connected at its bottom end to the inner element for operating the grinder. Screw threads formed on the shaft and an adjuster knob are engaged such that rotation of the adjuster knob directly moves the inner grinding element axially for adjusting the size of the ground condiment. A sleeve fixed to the inner grinding element slides axially on the shaft but is fixed to rotate with the shaft. Mating snap-acting connectors on the sleeve and the adjuster knob are joined by elastic deformation.

### TECHNICAL FIELD

The present invention relates to grinders for condiments such as pepper or salt, with means for adjusting the size of the ground condiment.

### BACKGROUND OF THE INVENTION

In a traditional hand held condiment grinder the housing defines a condiment reservoir and a rotary handle at the top of the housing is connected by a shaft extending centrally through the housing to a grinding mechanism at its bottom end. The grinding mechanism includes coaxial inner and outer grinding elements, the space between which defines the size of the ground product. The outer element is fixed to the housing and the shaft is connected at its bottom end to the inner element and at its top end by a screw threaded knob to the handle. Rotation of the knob allows the axial position of the inner element to be varied to adjust the fineness of the ground product.

Electrically-operated cordless grinders are also known in the prior art in which, in place of the handle at the top of the housing and the through-extending shaft, is a compartment for holding batteries, an electric motor and gearbox which drive the inner grinding element. Some of the drawbacks regarding these grinders are that they do not permit a large range of grind fineness, or do not provide for a continuously variable grind size and some require dismantling in order to make adjustment between grind sizes. It is an object of the present invention to overcome or substantially ameliorate the above disadvantages or more generally to provide an improved condiment grinder.

### DISCLOSURE OF THE INVENTION

According to one aspect of the present invention there is provided a condiment grinder comprising:

a housing;

a shaft having a central axis supported for rotation in the housing, the shaft having a screw thread formed at a first longitudinal end;

an inner grinding element mounted to the shaft to rotate therewith and to move relative to the shaft in the axial direction;

an outer grinding element mounted substantially coaxially with the inner grinding element to define a space therebetween for receiving the condiment to be ground;

an adjuster knob having a screw thread engaged with the thread on the first end of the shaft, and

cooperating connector means joining the adjuster knob and inner grinding element such that rotation of the adjuster knob relative to the inner grinding element in either sense directly moves the inner grinding element axially for adjusting the size of the ground condiment.

Preferably the grinder further comprises a sleeve received in and fixed to the inner grinding element, the sleeve having an aperture receiving the shaft, an inner face on the sleeve cooperating with an outer face on the shaft to prevent rotation of the sleeve relative to the shaft about the central axis while allowing axial movement of the sleeve relative to the shaft,

the connector means comprising mating snap-acting connectors joining, by elastic deformation, the adjuster knob and sleeve.

Preferably the snap-acting connectors comprise an annular bead having a bead axis coaxial with the central axis and a complementary annular recess.

The sleeve preferably has a through-extending opening for receiving the shaft and includes an elongate neck and a head, the neck having a smaller transverse dimension than the head, the annular recess being formed in the through-extending opening at a first longitudinal end of the sleeve, the annular bead projecting from a transverse surface of the adjuster knob, the inner grinding element having a grinding surface converging from a first end to a second opposing end, the inner grinding element having an aperture of complementary shape to the sleeve with a portion of the aperture at the first end receiving the head of the sleeve and a portion of the aperture at the second end receiving the neck.

Preferably the sleeve and the inner grinding element include mutually engaged projections and recesses for preventing relative rotation therebetween, an annular rib on the sleeve cooperating with a shoulder on the outer grinding element to prevent relative axial movement between the inner grinding element and sleeve.

The inner grinding element and adjuster knob are preferably formed of polymers which are relatively harder than a polymer from which the sleeve is formed.

Preferably a second longitudinal end of the sleeve includes an abutment face for abutting a stop at an innermost limit of travel of the sleeve and attached inner grinding element.

The grinder preferably further includes a reservoir in a lower part of the housing in communication with the grinding elements, the shaft extending through the reservoir and drivingly connected to an electric motor driven gearbox, the housing further enclosing a battery compartment for receiving batteries for driving the motor.

By providing mating snap-acting connectors joining the adjuster knob and sleeve the grinder, combined with the cooperating screw threads on the shaft and knob provides a continuously variable, stepless and reliable adjustability in both directions. Moreover it is a simple design which may be economically manufactured.

### BRIEF DESCRIPTION OF THE DRAWINGS

Preferred forms of the present invention will now be described by way of example with reference to the accompanying drawings, wherein:

FIG. 1 is a longitudinal cross section of a preferred embodiment of the grinder of the invention;

FIG. 2 is an exploded view of a rotor assembly of the grinder FIG. 1;

FIG. 3 is a longitudinal cross section of the rotor assembly of FIG. 2 when assembled;

FIG. 4 is an end view of the rotor of the grinder of FIG. 1, and

FIG. 5 is an end view of the sleeve of the grinder of FIG. 1.

### DESCRIPTION OF THE PREFERRED EMBODIMENTS

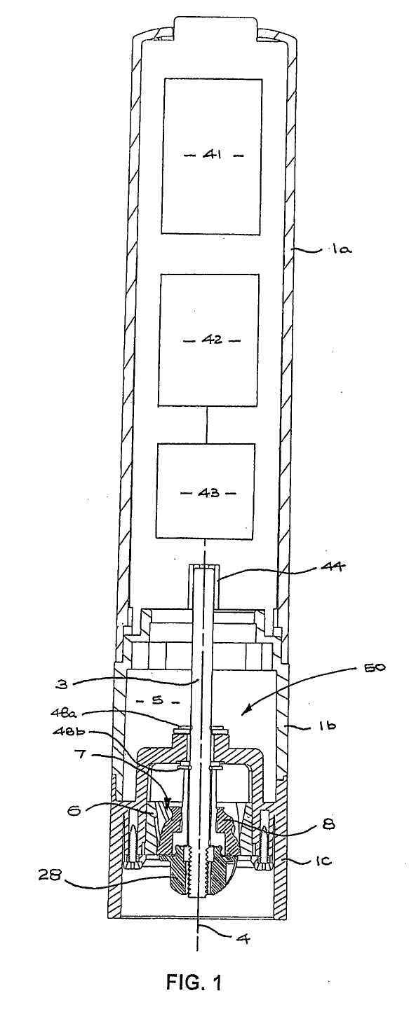

Referring to FIG. 1 of the drawings, a hand held electrically operated, cordless grinder includes a housing having an upper housing part 1a with cylindrical walls enclosing a battery compartment 41, an electric motor 42 and gearbox 43. A central housing part 1b defines a reservoir 5 for receiving condiments such as peppercorns and rock salt. A lower housing part 1c mounts a rotor assembly 50. The motor 42 and gearbox 43 rotate a socket 44, the socket 44 drivingly engaging the upper end of an elongate shaft 3 extending centrally through the reservoir 5. The shaft 3 is supported for rotation about the longitudinal axis 4 and located axially by inner and outer clips 48a, 48b respectively engaged in circumferential grooves in the shaft 3.

As used herein, the term “axial” refers to a direction substantially parallel to the longitudinal axis 4. The term “radial” refers to a direction substantially orthogonal to the longitudinal axis 4. The term “circumferential” refers to the direction of a circular arc having a radius substantially orthogonal to the longitudinal axis 4.

Fixed at the base of the reservoir 5 is an outer grinding element or stator 6 with an axially extending opening 7 receiving the inner grinding element or rotor 8 attached to the shaft 3. An adjuster knob 28 is fixed on the bottom end of the shaft 3 for adjusting the spacing between the rotor 8 and stator 6.

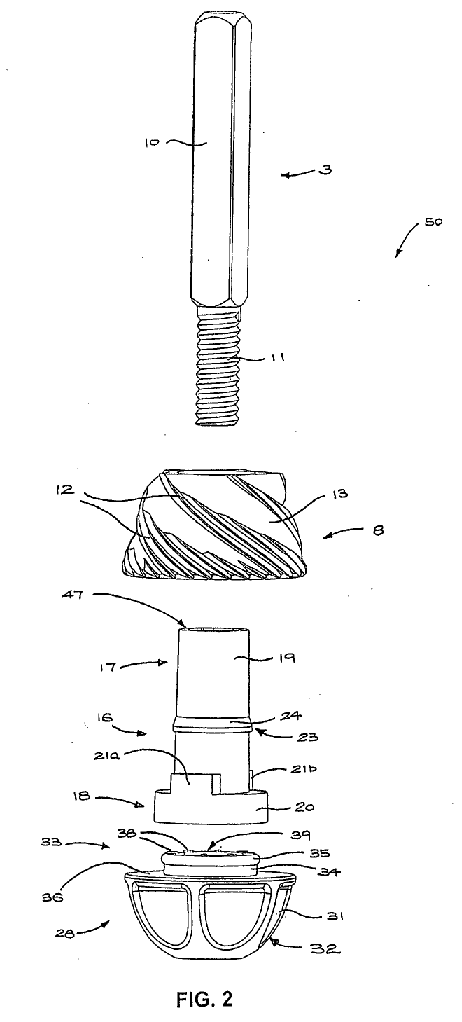

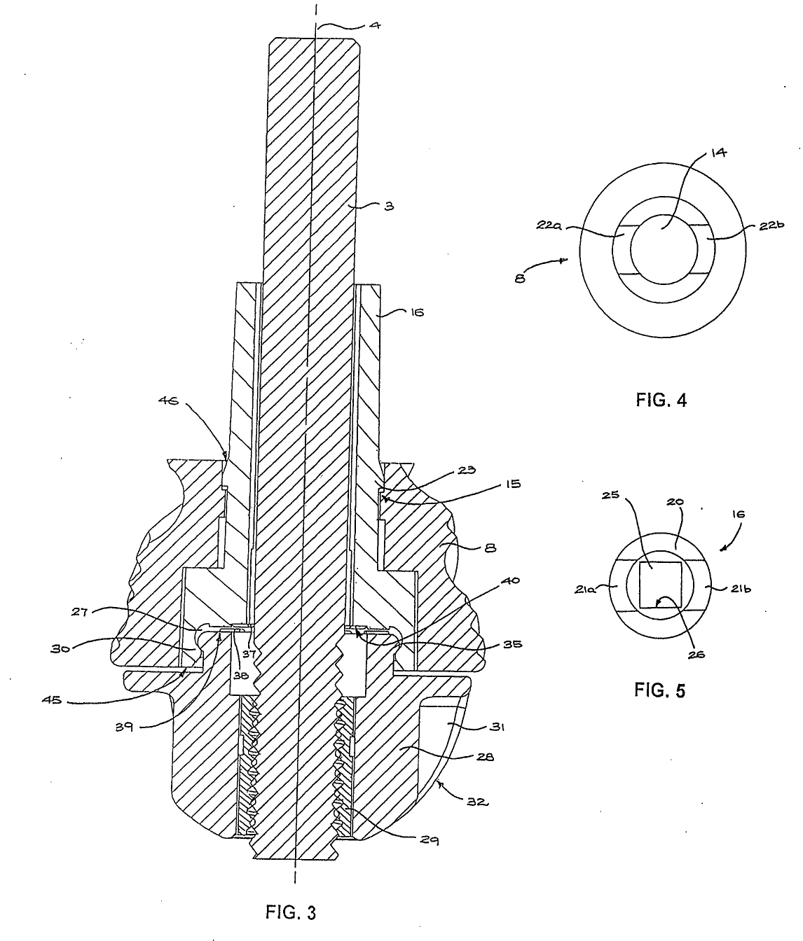

As best seen in FIGS. 2 to 5, the rotor assembly 50 includes the shaft 3, rotor 8, a sleeve 16 and an adjuster knob 28. The shaft 3 is formed of aluminium and has a square cross section with planar faces 10 and a screw thread 11 is formed on its lower end.

The rotor 8 has an outer face 13 tapering outwardly from top to bottom in the axial direction and on which a plurality of spiral ridges 12 are formed. An axially-extending aperture 14 includes a shoulder 15. The aperture 14 has a generally stepped shape, the lower mouth 45 of the aperture having a greater transverse dimension than the upper mouth 46. The rotor 8 is made of a relatively hard polymer such as polytetrafluoroethylene.

Received in the aperture 14, the flexible sleeve 16 has a narrow elongate neck 17 and a wider head 18 both with coaxial cylindrical surfaces 19, 20 respectively. Two diametrically opposing projections 21a, 21b on the sleeve 16 are received in respective recesses 22a, 22b for preventing relative rotation between the rotor 8 and sleeve 16. An annular rib 23 formed integrally with the sleeve 16 and has a divergent face 24 that projects from the surface 19. The aperture 14 has a stepped shape complementary to the sleeve 16, and the sleeve 16 is deformed elastically when pressed into the aperture 14, to bring the divergent face 24 to engage the shoulder 15. Once pushed past the shoulder 15 the head 18 is completely recessed in the rotor 8, the shoulder and rib cooperate to prevent relative axial movement between the rotor and sleeve.

At the outer end of the head 18 an annular recess 27 is formed in the opening 25, extending radially inwardly from an axially adjacent annular lip 30. Adjacent the recess 27 a generally radially-extending face 40 includes small circumferentially spaced convexities 37. At the inner end of the neck 17 an annular abutment face 47 is provided for abutting the outer clip 48b (see FIG. 1), which thereby also provides a stop at an innermost limit of travel of the sleeve 16 and attached rotor 8.

From the annular lip 30 and recess 27, the axially-extending opening 25 through the rest of the head 18 and neck 17 is of a square cross section complementary to the shaft 16, having planar faces 26 cooperating with the faces 10 to prevent rotation of the sleeve 16 relative to the shaft 3 about the central axis 4, while permitting relative axial sliding movement. The sleeve 16 is made of a soft and resilient polymer such as polypropylene.

The adjuster knob 28 is made of a relatively hard and stiff polymer such as un-plasticized polyvinylchloride and includes a metallic thread insert 29 with a screw threaded through-extending opening therein. The insert 29 is fixed, such as by moulding the adjuster knob 28 around the thread insert 29, an interference fit, or the like. A plurality of circumferentially spaced indentations 31 are formed in the dome-shaped face 32 for improved purchase on the knob 28 during manipulation.

A projection 33 extends axially from a radially-aligned face 36 at the inner end of the adjuster knob 28 and has a cylindrical transverse face 34 coaxial with the central axis 4. An annular bead 35 projects radially outwardly of the face 34 at the end of the projection 33 and has a toroidal outer face. The innermost face 39 of the knob 28 is generally radially-extending and includes small circumferentially spaced protruberances 38.

During assembly of the grinder, the knob 28 and sleeve 16 are connected by a snap fit, the snap-acting connectors comprising the annular recess 27 and annular bead 35. The projection 33 is pressed into the opening 25, the bead 35 engaging and resiliently deforming the lip 30. The difference in relative hardness of the materials of the sleeve 16 and knob 28 means that the sleeve 16 is preferentially deformed in an elastic manner. The relative radial clearance between the head 18 and the head-receiving portion of the aperture 14 also influences the snap action of this connection. With the bead 35 received in the recess 27 the sleeve 16 retains the adjuster knob 28, while allowing it to rotate.

To adjust the size of ground condiment, the user grasps and rotates the knob 28. Due to a small clearance between the protruberances 38 and convexities 37 on the axially opposing faces 39, 40 when the bead 35 is in contact with the lip 30, the knob 28 rotates freely. As the sleeve 16 is restrained to move axially and cannot rotate, the axial displacement of the knob 28 provides, by virtue of the engagement between the bead 35 and recess 27, a generally corresponding axial displacement of the sleeve 16 and the attached rotor 8. Due to the tapered shape of the rotor 8 this axial movement varies the spacing between the rotor and stator, which is increased to produce larger particles and reduced to produce smaller particles.

Aspects of the present invention have been described by way of example only and it should be appreciated that modifications and additions may be made thereto without departing from the scope thereof.

1. A condiment grinder comprising:
a housing;
a shaft having a central axis supported for rotation in the housing, the shaft having a screw thread formed at a first longitudinal end;
an inner grinding element mounted to the shaft to rotate therewith and to move relative to the shaft in the axial direction;
an outer grinding element mounted substantially coaxially with the inner grinding element to define a space therebetween for receiving the condiment to be ground;
an adjuster knob having a screw thread engaged with the thread on the first end of the shaft, and
cooperating connector means joining the adjuster knob and inner grinding element such that rotation of the adjuster knob relative to the inner grinding element in either sense directly moves the inner grinding element axially for adjusting the size of the ground condiment.

2. The grinder of claim 1 further comprising a sleeve received in and fixed to the inner grinding element, the sleeve having an aperture receiving the shaft, an inner face on the sleeve cooperating with an outer face on the shaft to prevent rotation of the sleeve relative to the shaft about the central axis while allowing axial movement of the sleeve relative to the shaft,
the connector means comprising mating snap-acting connectors joining, by elastic deformation, the adjuster knob and sleeve.

3. The grinder of claim 2 wherein the snap-acting connectors comprise an annular bead having a bead axis coaxial with the central axis and a complementary annular recess.

4. The grinder of claim 3 wherein the sleeve has a through-extending opening for receiving the shaft and includes an elongate neck and a head, the neck having a smaller transverse dimension than the head, the annular recess being formed in the through-extending opening at a first longitudinal end of the sleeve, the annular bead projecting from a transverse surface of the adjuster knob, the inner grinding element having a grinding surface converging from a first end to a second opposing end, the inner grinding element having an aperture of complementary shape to the sleeve with a portion of the aperture at the first end receiving the head of the sleeve and a portion of the aperture at the second end receiving the neck

5. The grinder of claim 4 wherein the sleeve and the inner grinding element include mutually engaged projections and recesses for preventing relative rotation therebetween, an annular rib on the sleeve cooperating with a shoulder on the outer grinding element to prevent relative axial movement between the inner grinding element and sleeve.

6. The grinder of claim 5 wherein the inner grinding element and adjuster knob are formed of polymers which are relatively harder than a polymer from which the sleeve is formed

7. The grinder of claim 6 wherein a second longitudinal end of the sleeve includes an abutment face for abutting a stop at an innermost limit of travel of the sleeve and attached inner grinding element.

8. The grinder of claim 1 further including a reservoir in a lower part of the housing in communication with the grinding elements, the shaft extending through the reservoir and drivingly connected to an electric motor driven gearbox, the housing further enclosing a battery compartment for receiving batteries for driving the motor.
